(19) United States
(12) Patent Application Publication
(10) Pub. No.: US 2014/0334656 A1
(43) Pub. Date: Nov. 13, 2014

(54) HEADPHONE WITH PASSIVE DIAPHRAGM

(71) Applicant: DEXIN CORPORATION, New Taipei City (TW)

(72) Inventor: TUNG-KO LU, NEW TAIPEI CITY (TW)

(73) Assignee: DEXIN CORPORATION, New Taipei City (TW)

(21) Appl. No.: 13/959,785

(22) Filed: Aug. 6, 2013

(30) Foreign Application Priority Data
May 8, 2013 (TW) 102116350

(51) Int. Cl. H04R 1/10

(52) U.S. Cl. CPC H04R 1/10
USPC 381/370

(57) ABSTRACT

A headphone with passive diaphragm is adapted to engage to the user's ear. The headphone with passive diaphragm includes an acoustic generator and a diaphragm assembly. The diaphragm assembly includes an annular member and a passive diaphragm. The acoustic generator is configured at a proximal end of the annular member near the user's ear. The passive diaphragm is configured to seal the annular member at a distal end thereof away from the user's ear. The passive diaphragm, annular member, and the acoustic generator cooperatively form a rear chamber.

### BACKGROUND OF THE INVENTION

1. Field of the Invention

The instant disclosure relates to a headphone having passive diaphragm, in particular, to a headphone which uses a passive diaphragm to form a rear chamber of an acoustic generator.

2. Description of Related Art

Headphones are typical accessories for music listening, as well as a suitable tool for not disturbing people in the surrounding. Since headphones are typically portable accessories, portable headphones are typically small in size and lightweight.

However, since the casing of the conventional headphone typically forms an enclosed space and the sound output is limited by the volume of the enclosed space, thus, the bass performance tends to be poor. The conventional manufacturing of a preferable bass headphone typically provides a sealed acoustic cavity. However, since the sealed acoustic cavity has a significant dampening effect on an acoustic generator, when a low frequency sound is emitted, the bass performance of the headphone suffers due to the lack of power in the acoustic generator and thus, is less likely to provide sufficient resonance. Therefore, the sound generated seems muffled.

As a result, the current industry introduces openings to the acoustic cavity, and seals the openings with the semi-air permeable paper such that the acoustic cavity and the area outside of the acoustic cavity are air communicable and the dampening effect on the acoustic generator by the acoustic cavity is reduced. However, such method produces excess noises and sounds, which are of nuisance to users. In addition, the semi-air permeable paper will render the accuracy of the low frequency impedance difficult to control at a certain range, thus, the sound performance is not preferable and the dynamic response of low frequency sound is poor.

To address the above issues, the inventor strives via associated experience and research to present the instant disclosure, which can effectively improve the limitation described above.

### SUMMARY OF THE INVENTION

The object of the instant disclosure is to provide a headphone having a sealed acoustic cavity without over dampening.

In order to achieve the aforementioned objects, according to an embodiment of the instant disclosure, a headphone having passive diaphragm adapted to engage to the user's ear is provided. The headphone with passive diaphragm includes an acoustic generator and a diaphragm assembly. The diaphragm assembly includes an annular member and a passive diaphragm. The acoustic generator is configured at a proximal end of the annular member near the user's ear. The passive diaphragm is configured to seal the annular member at a distal end thereof away from the user's ear. The passive diaphragm, annular member, and the acoustic generator cooperatively form a rear chamber.

The instant disclosure provides the following improvement. The instant disclosure provides the appropriate dampening and relatively better bass performance via the sealed and adjustable volume rear chamber formed by the diaphragm assembly and the acoustic generator.

In order to further understand the instant disclosure, the following embodiments and illustrations are provided. However, the detailed description and drawings are merely illustrative of the disclosure, rather than limiting the scope being defined by the appended claims and equivalents thereof.

### BRIEF DESCRIPTION OF THE DRAWINGS

FIG. 1 is a cross-sectional view of a headphone with passive diaphragm in accordance with the instant disclosure;

FIG. 2 is an exploded view of the headphone with passive diaphragm in accordance with the instant disclosure;

FIG. 3 is another exploded view of the headphone with passive diaphragm in accordance with the instant disclosure;

FIG. 4 is an exploded view illustrating a diaphragm assembly of the headphone with passive diaphragm in accordance with the instant disclosure;

FIG. 5 is a schematic diagram illustrating the appearance of the headphone with passive diaphragm in accordance with the instant disclosure; and

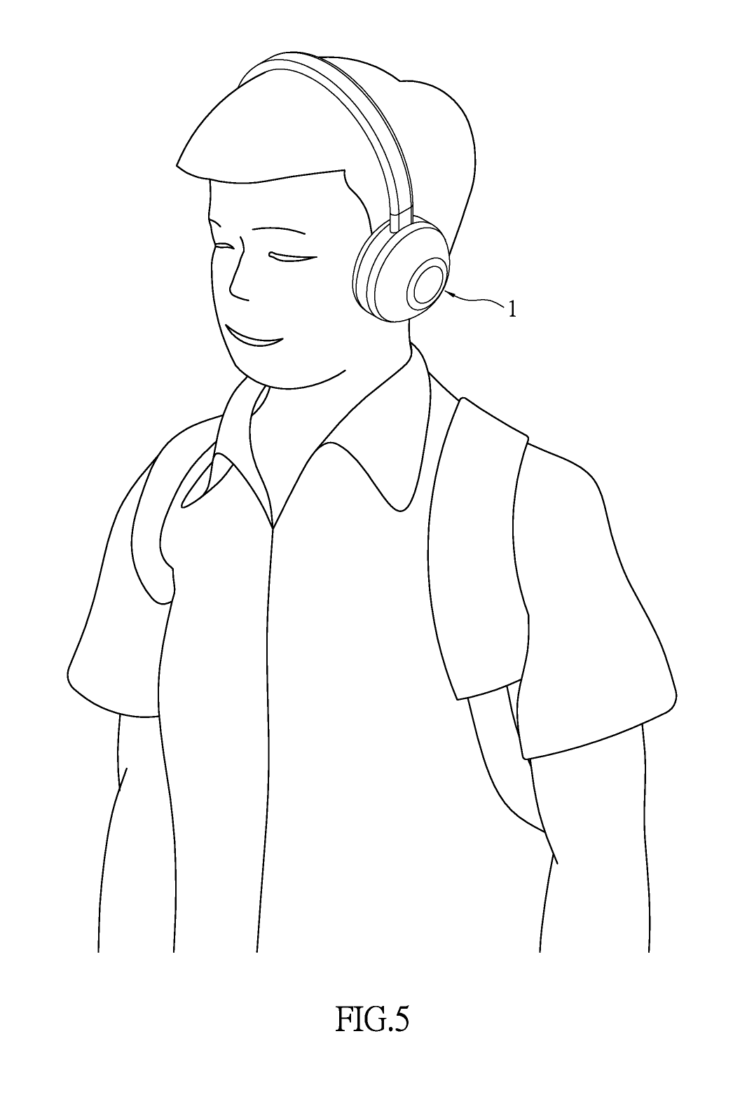

FIG. 6 is a graph illustrating the impedance of the headphone with passive diaphragm in accordance with the instant disclosure.

### DETAILED DESCRIPTION OF THE PREFERRED EMBODIMENTS

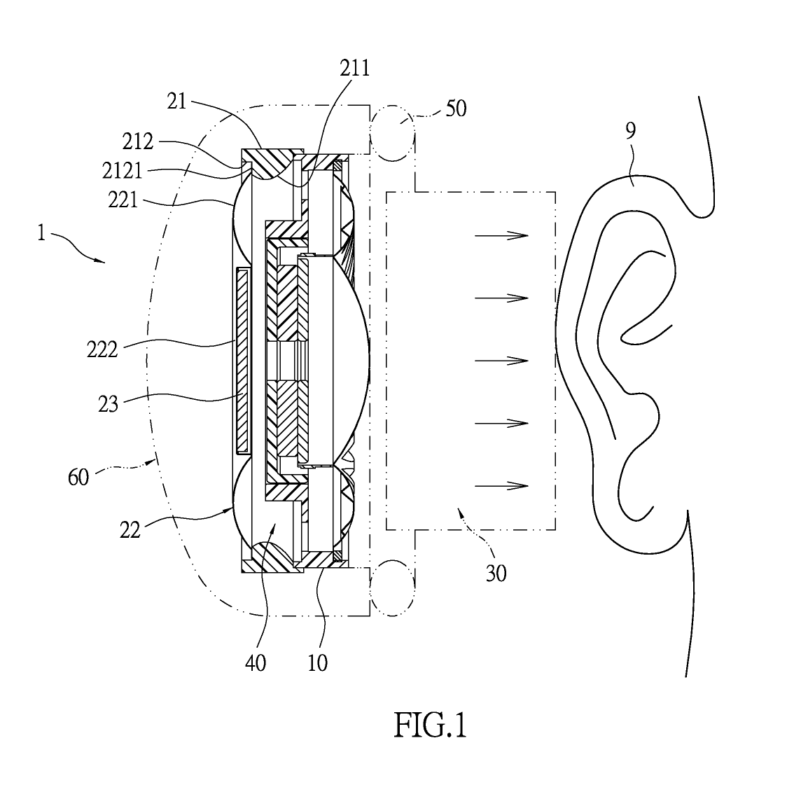

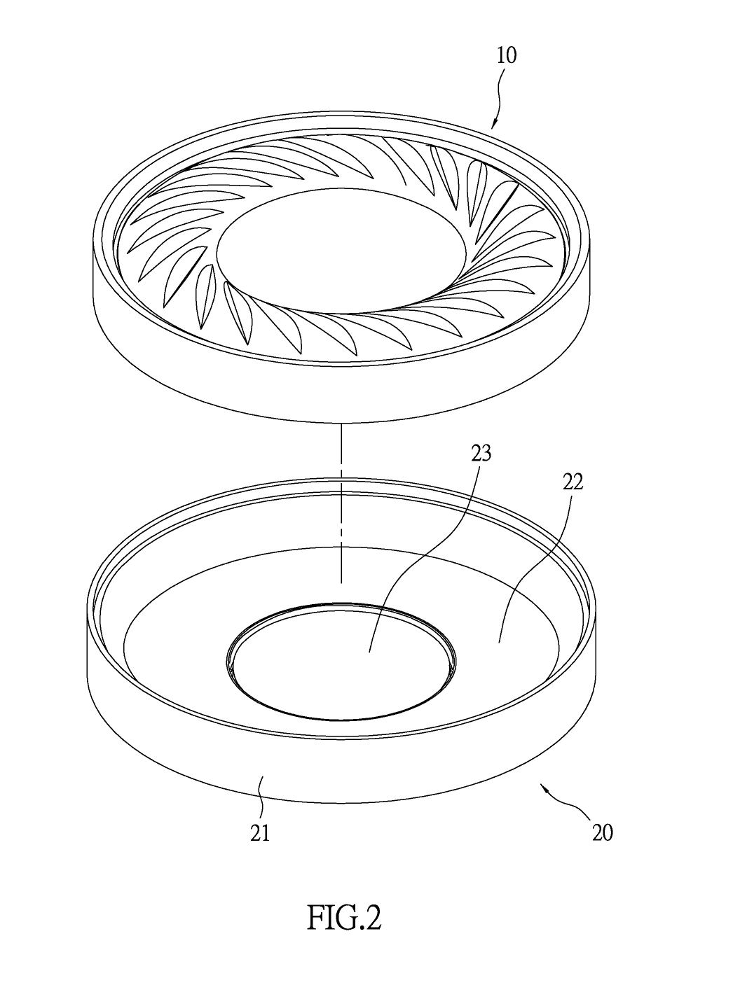

As shown in FIG. 1, the instant disclosure provides a headphone with passive diaphragm 1, adapted to engage a user's ear 9. The headphone with passive diaphragm 1 comprises an acoustic generator 10, and a diaphragm assembly 20 (as shown in FIG. 2) and an elastic member 50. The diaphragm assembly 20 is configured at an end of the acoustic generator 10, and the elastic member 50 is configured at a proximal end of the acoustic generator 10 near the user's ear 9.

The acoustic generator 10 can be driven by dynamic, static, balanced armature, or various types of mechanisms depending on the overall preference of the headphone 1, and the overall preference is based on any or any combination of the following factors such as cost, frequency, sensitivity requirement, sound quality, and usable life. The elastic member 50 is substantially high density foam ear pads, silicon earplugs, or form ear plugs. When the elastic member 50 is in use, a proximal end is adapted to engage the user's ear to improve the airtightness between the headphone with passive diaphragm 1 and the user's ear, as well as comfort of the user. The choice of the elastic member 50 depends on the position thereof relatively to the user's ear. For example, if the elastic member 50 is to be disposed in the user's ear, and the headphone with passive diaphragm 1 is an in-ear type headphone, the earplug or any similar type of headphones is selected as the elastic member 50. The elastic member 50 of the instant embodiment is adapted to engage the pinna of the user's ear. In other words, the headphone with passive diaphragm 1 is for example (as shown in FIG. 7) a circumaural headphone, and as such, the elastic member 50 is an ear pad.

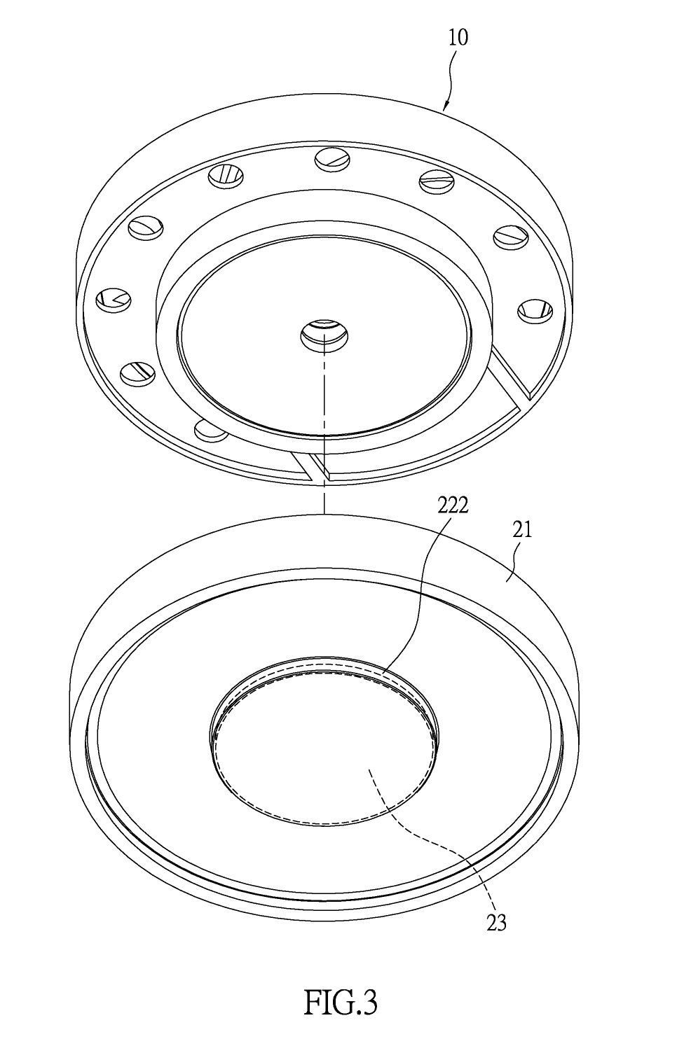

As illustrated in FIGS. 1, 2, and 3, the diaphragm assembly includes an annular member 21, a passive diaphragm 22, and a weight member 23. The passive diaphragm 22 is configured to seal the annular member 21 at a distal end thereof away from the user's ear. As shown in FIG. 1, the annular member 21 has an inner side surface, and the inner side surface has an arc portion 211. The arc portion 211 arcs towards a center of the annular member 21. In other words, an inner diameter of the annular member 21 decreases from an proximal end near the user's ear 9 and then increases towards a distal end away from the user's ear 9. The aforementioned structure provides smooth airflow to flow the arc portion 211, and the air flowing the arc portion 211 is correspondingly compressed such that sound frequency changes.

The distal end of the annular member 21 has a fixing portion 212 arranged thereon. The fixing portion 212 and the arc portion 211 cooperatively form a fixing surface 2121 at the intersection point therebetween. The passive diaphragm 22 abuts the fixing surface 2121 such that the passive diaphragm 22 can securely dispose on the annular member 21. In another embodiment of the instant disclosure, the passive diaphragm 22 is disposed in a silicon ring (not shown in figures). The silicon ring is disposed on the fixing portion 212. An outer diameter of the silicon ring is slightly larger the inner diameter of the fixing portion 212 and the silicon ring abuts the fixing surface 2121 such that the silicon ring and the passive diaphragm 22 are securely disposed on the fixing portion 212.

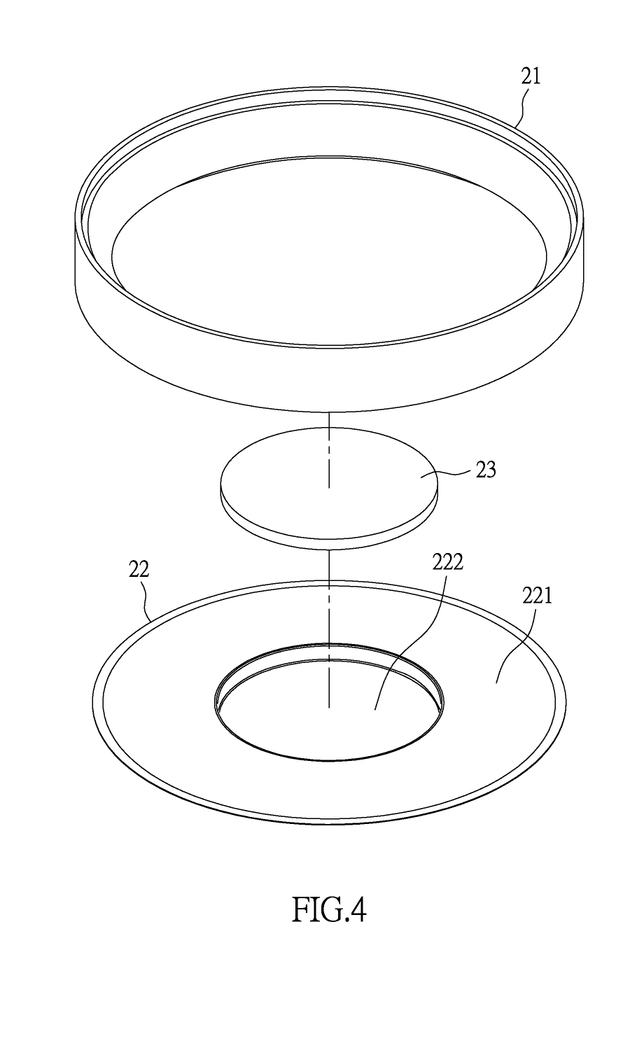

As shown in FIGS. 1 and 4, the passive diaphragm 22 has an annular protrusion 221 and a center protrusion 222. Both protrusions 221, 222 protrude away from the direction of the user's ear 9. The annular protrusion 221 is arranged around the center protrusion 222. The weight member 23 is configured at the center protrusion 222 to increase the force required to drive the passive diaphragm 22. The weight of the weight member 23 is adjusted based on the sensitivity and tone quality demands of the headphone 1. The passive diaphragm 22 is made of air-impermeable materials. In another embodiment of the instant disclosure, the materials per se can provide sensitivity, tone quality, and dampening demands.

As shown in FIG. 1, the acoustic generator 10 is configured at a proximal end of the annular member 21 near the user's ear 9, and the passive diaphragm 22 seals the distal end of the annular member 21 away from the user's ear 9, such that the diaphragm assembly 20 and the acoustic generator 10 cooperatively form a substantially sealed rear chamber 40. Furthermore, when the headphone with the passive diaphragm 1 is adapted to engage the user's ear, the elastic member 50 abuts the pinna of the user's ear 9 such that the elastic member 50, the acoustic generator 10 and the user's ear cooperatively form a front chamber 30.

Since the passive diaphragm 22 is elastic, when the acoustic generator 10 vibrates, the air pressure in the front chamber 30 and the rear chamber 40 fluctuates, and the passive diaphragm 22 in turn slight vibrates due to the air pressure change in the rear chamber 40 such that the volume of the rear chamber 40 changes. As a result, the rear chamber 40 has a relatively small dampening effect on the acoustic generator 10. In addition, since the passive diaphragm 22 is made of an impermeable material, the air within the rear chamber 40 and the air outside of the headphone 1 are not communicable, thus, excess noise are not generated and the bass tone is relatively cleaner. Moreover, due to the configuration of the annular protrusion 221 and the center protrusion 222, the passive diaphragm 22 has relatively smoother vibrations. Furthermore, since the annular protrusion 221 and the center protrusion 222 protrude away from the direction of the user's ear 9, the volume of the rear chamber 40 is relatively large, which increases the space for resonance, thus, the bass tone relatively better.

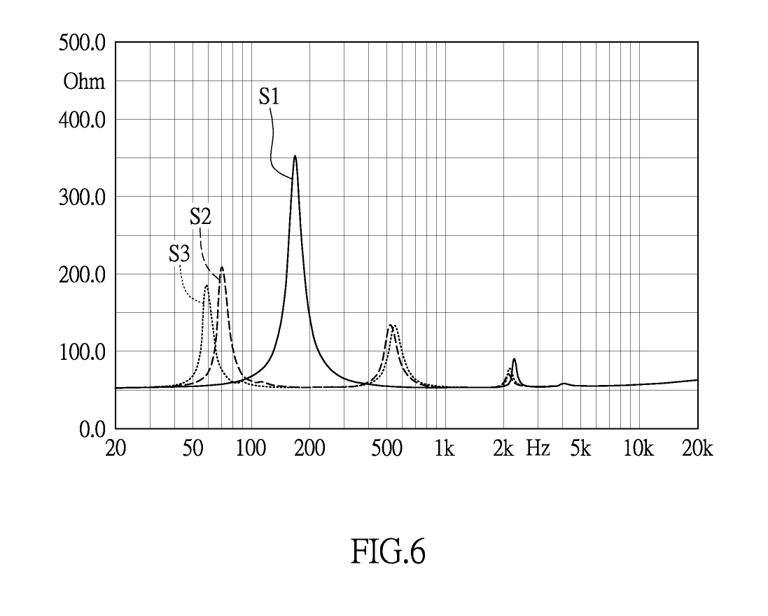

Please refer to FIGS. 1 and 6. In the instant embodiment of the instant disclosure, the headphone with passive diaphragm 1 comprises a casing 60. The acoustic generator 10 and the diaphragm assembly 20 are accommodated in the casing 60. The acoustic generator 10 is exposed through the casing 60 such that the acoustic generator 10 generates sounds towards the user's ear 9. The elastic member 50 is configured at a proximal end of the casing 60 near the user's ear 9 such that the headphone with passive diaphragm 1 resembles a circumaural headphone structure.

FIG. 6 is an experimental graph illustrating impedance of the headphone with passive diaphragm 1 under various states as a function of frequency. S1 represents the impedance curve when the acoustic generator 10 is in direct air communication with the atmosphere, and S2 to S3 represents the impedance curves when the acoustic generator 10 and the diaphragm assembly are assembled. In particular, the weight of the weight member 23 at S2 is 1 gram. The weight of the weight member 23 at S3 is 1.5 gram. As shown in FIGS. 1 and 6, the minimum resonance frequency of S1 is about 200 Hz (hertz), the minimum resonance frequency of S2 is about 70 Hz, and the minimum resonance frequency of S3 is about 60 Hz. S1 has the largest minimum resonance frequency, whereas S3 has the lowest minimum resonance frequency. When the headphone with the passive diaphragm 1 requires a relatively low tone, a relatively heavier weight should be used as the weight member 23. As a result, the heavier the weight member 23, the larger dampening effect the rear chamber 40 has on the acoustic generator 10.

Notably, the headphone with passive diaphragm 1 of the instant disclosure characterizes in that through the sealed and adjustable volume rear chamber 40 formed by the diaphragm assembly 20 and the acoustic generator 10, the headphone with passive diaphragm 1 has the completely sealed chamber as of the conventional arts, which will not over dampen to lose bass performance and can prevent excess noises generated by the well-known ventilating openings for dampening. In addition, with the weight member 23, manufacturers can determine the weight of the weight member 23 according to the required specifications of the headphone with passive diaphragm 1. As a result, the instant disclosure can control the low frequency impedance, and thus, sound quality is cleaner.

The figures and descriptions supra set forth illustrated the preferred embodiments of the instant disclosure; however, the characteristics of the instant disclosure are by no means restricted thereto. All changes, alternations, combinations or modifications conveniently considered by those skilled in the art are deemed to be encompassed within the scope of the instant disclosure delineated by the following claims.

What is claimed is:

1. A passive diaphragm embedded headphone adapted to engage a user's ear, comprising:
an acoustic generator; and
a diaphragm assembly including an annular member and a passive diaphragm;
wherein the acoustic generator is configured at a proximal end of the annular member near the user's ear, the passive diaphragm is configured to seal the annular member at a distal end thereof away from the user's ear, and the passive diaphragm, the annular member, and the acoustic generator cooperatively form a rear chamber.

2. The headphone with passive diaphragm as recited in claim 1, wherein the annular member has an inner side surface, and the inner side surface has an arc portion.

3. The headphone with passive diaphragm as recited in claim 2, wherein the arc portion arcs towards a center of the annular member.

4. The headphone with passive diaphragm as recited in claim 1, wherein the passive diaphragm has a weight member configured thereat.

5. The headphone with passive diaphragm as recited in claim 1, wherein the passive diaphragm includes an annular protrusion and a center protrusion, and the annular protrusion is arranged around the center protrusion.

6. The headphone with passive diaphragm as recited in claim 5, wherein the passive diaphragm has a weight member configured thereat, and the weight member is configured at the center protrusion.

7. The headphone with passive diaphragm as recited in claim 1, wherein the annular member has a fixing portion arranged on the distal end thereof away from the user's ear, and the passive diaphragm is partially fixed at the fixing portion.

8. The headphone with passive diaphragm as recited in claim 7, wherein the annular member has an inner side surface, the inner side surface has an arc portion, and an end of the fixing portion proximate to the arc portion has a fixing surface arranged thereon.

9. The headphone with passive diaphragm as recited in claim 1 further comprising:
an elastic member configured around the acoustic generator at a proximal end thereof near the user's ear, and the elastic member, the acoustic generator and the user's ear cooperatively forming a front chamber.
